(19) United States
(12) Patent Application Publication
(10) Pub. No.: US 2019/0213674 A1
(43) Pub. Date: Jul. 11, 2019

(54) DYNAMIC AUTO LOAN ORIGINATION

(71) Applicant: ILENDX LLC, San Antonio, TX (US)

(72) Inventors: Andrew Joseph Ivankovich, San Antonio, TX (US); Luther G. Branham, III, San Antonio, TX (US); Mark Wilson Scott, Sugar Land, TX (US); Robert Pearce Kraft, III, Thousand Oaks, CA (US)

(73) Assignee: ILENDX LLC, San Antonio, TX (US)

(21) Appl. No.: 15/692,680

(22) Filed: Aug. 31, 2017

(51) Int. Cl. G06Q 40/02; G06Q 30/06

(52) U.S. Cl. CPC G06Q 40/025; G06Q 30/06

(57) ABSTRACT

Disclosed is an approach for dynamic loan origination that separates objectively easy-to-approve loan applicants suitable for automated, streamlined, and fast-tracked loan origination for real-time loan approval (which comprise the majority of loan applications) from applicants that may be declined or may require special consideration for approval or decline (for which traditional non-real-time loan origination processes are better suited). In operation, the separation of the objectively easy approvals from the possible disapproval may be performed by a third-party non-lending pre-origination provider that is distinct and separate from a lender.

### BACKGROUND

Auto loan origination is the process by which a borrower secures an auto loan from a lender for the purchase of a new or used vehicle. This process generally includes all the steps from receiving a loan application up to disbursement of funds (if successful) or declining to make the loan (if unsuccessful).

The auto loan origination process commences with the would-be borrower filing with the lender a formal application for the auto loan. The formal application includes an application form to be completed by the applicant, and the applicant is also required to submit various supporting documents to affirm applicant's financial well-being, said documents including (but not limited to) evidence of current income, current assets, estimates of existing debt obligations, and current credit score (or permission by the applicant for the lender to obtain the credit score and/or a full credit report on the applicant's behalf). Once an application for an auto loan is initiated, the would-be borrower is deemed an applicant for an auto loan, and from that point forward lenders are required to comply with various federal and state rules and regulations in processing the application and deciding whether or not to make the loan.

Many factors contribute to the decision-making process a lender undertakes in determining whether or not to grant an auto loan. An important factor to lenders is compliance with various federal and state rules and regulations that govern approvals and declines of loans, and compliance with the various regulations is often complicated and time-consuming for the lender. This is especially true for loan applicants who do not fall into easily approvable ranges of various criteria that are evaluated and considered, for which additional consideration may be warranted and necessary to lead to an approval, or for which disapproval of the loan is the outcome. As such, auto loan applications may be divided into three groups: those that are easily approved objectively, those requiring special approval based on custom consideration, and those that are ultimately disapproved (either objectively or for not qualifying for special approval). Most federal and state rules and regulations pertain to loan declines (a.k.a. adverse actions) in order to ensure that any decline of the loan application is made only for objective and fair reasons and not for illegal reasons (e.g., discrimination against any protected class of persons or redlining).

For these reason, processing loan applications is difficult and time-consuming for lenders who are effectively unable to provide real-time decision-making for auto loan origination because of the possibility that any particular application may require special approval or disapproval which is determinable by the lender only once an application is filed. This legacy approach, however, has not kept pace with the auto purchasing marketplace where would-be borrowers—most of whom are objectively easily approved for loans—would collectively benefit from real-time decision-making and financing for their automobile purchases. Accordingly, there is a need in the art for dynamic auto loan origination to provide would-be borrowers with near-instant auto loan approvals (or declines).

### SUMMARY

Disclosed herein are various implementations directed to systems, processes, methods, and other implementations for dynamic auto loan origination.

More specifically, disclosed herein are various implementations directed to loan pre-origination performed by a non-lending pre-origination provider separate from a lender (“provider”) comprising: receiving from the lender a plurality of requirement parameters for a real-time approval of one or more loans offered by the lender; receiving first applicant information from a first applicant seeking a first loan from the lender; performing an assessment of the first applicant information to derive assessment results, the assessment based on the plurality of requirement parameters applied to the first applicant information, and the assessment results indicating whether the first applicant qualifies for the real-time approval of at least one loan from among the one or more loans offered by the lender; transmitting to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender; and notifying the first applicant that the first applicant does not qualify for the real-time approval of the at least one loan from among the one or more loans offered by the lender if the assessment results indicate that the first applicant does not qualify for the real-time approval of at least one loan from among the one or more loans offered by the lender.

Also disclosed herein are various implementations directed to loan origination performed by a lender comprising: transmitting to a non-lending pre-origination provider separate from the lender (“provider”) a plurality of requirement parameters for real-time approval of one or more loans by the lender; receiving from the provider first applicant information from a first applicant seeking a first loan from the lender, and an indicator for the lender to grant real-time approval of at least one loan from among the one or more loans offered by the lender based on an assessment performed by the provider that indicates that the first applicant qualifies for the real-time approval of the at least one loan from among the one or more loans offered by the lender, the assessment based on the first applicant information and the plurality of requirement parameters; and granting real-time approval of the at least one loan from among the one or more loans offered by the lender to the applicant.

Also disclosed herein are various implementations directed to dynamic auto loan origination systems, methods, software, and hardware communicatively coupled to both a lender and a non-lending pre-origination provider separate from a lender (“provider”) that is configured to: receive from the lender a plurality of requirement parameters for a real-time approval of one or more loans offered by the lender; transmit to the provider the plurality of requirement parameters for real-time approval of one or more loans by the lender; receive from the provider first applicant information from a first applicant, and an indicator for the lender to grant real-time approval of at least one loan from among the one or more loans offered by the lender based on an assessment performed by the provider that indicates that the first applicant qualifies for the real-time approval of the at least one loan from among the one or more loans offered by the lender, the assessment based on the first applicant information and the plurality of requirement parameters; and transmit to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a block diagram illustrating an exemplary infrastructure that is capable of being used to secure financing for a purchase of a type that normally requires financing according to various implementations disclosed herein such as, for example, auto loans and auto loan origination;

FIG. 2 is a modified block diagram with process flow components illustrating the six-part pipeline of activities that form an exemplary auto loan origination process upon which various implementations disclosed herein are based;

FIG. 3A is a modified block diagram illustrating processing of auto loan applications from each of the three groups of applicants to demonstrate shortcomings addressed by various implementations disclosed herein;

FIG. 3B is a modified block diagram, similar to modified block diagram shown in FIG. 3A, but featuring a fast-track approval pipeline for the objectively easy approvals whereby applicants for auto loans, such as the applicant denoted as X, may be provided real-time auto loan approvals because such applicants are fully vetted in advance by the third-party provider;

FIG. 4 is a modified block diagram with process flow components based on the auto loan origination pipeline shown in FIG. 2 but further illustrating the modified pipeline of activities that form an exemplary dynamic auto loan origination process featuring fast-track processing for real-time approvals to which various implementations disclosed herein are directed;

FIG. 5 is a modified block diagram with process flow components of the pre-development function of FIG. 4 to which various implementations disclosed herein are directed;

FIG. 6 is a modified block diagram with process flow components of the pre-application function of FIG. 4 to which various implementations disclosed herein are directed;

FIG. 7 is a modified block diagram with process flow components of the pre-underwriting function of FIG. 4 to which various implementations disclosed herein are directed;

FIG. 8 is a modified block diagram with process flow components of the pre-offer function of FIG. 4 to which various implementations disclosed herein are directed;

FIG. 9 is a modified block diagram with process flow components of the pre-fulfillment function of FIG. 4 to which the various implementations disclosed herein are directed;

FIG. 10 is a process flow diagram of an exemplary process for dynamic auto loan origination to which various implementations disclosed herein are directed;

FIG. 11 is a process flow diagram of basic functions for an intermediary enabling the dynamic auto loan origination services of FIG. 4 and FIG. 10 as between a lender and a provider to which select implementations disclosed herein may be directed; and

FIG. 12 is a block diagram of an example computing environment that may be used in conjunction with example implementations and aspects.

### DETAILED DESCRIPTION

Disclosed herein are various implementations for dynamic auto loan origination. Various concepts helpful to more fully understand and appreciate these various implementations are herein described in support of the disclosures specifically pertaining to these various implementations that follow. These various implementations are directed to financing, and several such implementations described herein are specifically directed to auto purchase financing (“auto loans”); however, although these several such implementations may be described in the exemplary context of auto loans and auto loan origination, persons having ordinary skill in the art will understand that nothing herein is intended to limit any such implementations to auto loans and auto loan origination alone. Instead, all implementations described herein, including overarching concepts and methodologies, are intended to apply to financing of any kind including without limitation auto loans, home mortgage financing, recreational vehicle financing, boat loans, aircraft financing, educational financing, personal loans, and any other form of financing to which any of such implementations herein described may be reasonably applied without limitation. Stated differently, the disclosed implementations are applicable to any type of financing or monetary loan, and any description herein pertaining specifically to auto loans is for illustrative purposes as an exemplary type of financing among all the types of financing to which the various implementations disclosed herein may be applied.

As used herein, the terms “borrower” and “applicant,” whether alone or modified by various descriptors (e.g., “would-be borrower” or “potential borrower”), and although distinguishable in certain specific contexts to distinguish points in an auto loan origination process, are terms used interchangeably herein to denote persons or parties that seek an auto loan, and the use of one term or another is in no way intended to be limiting or restrictive. Likewise, any use of the terms “bank,” “credit union,” “financial institution,” and the like may also be used interchangeably herein to denote a “lender,” that is, the one extending an auto loan, and the use of one term or another is in no way intended to be limiting or restrictive. Additionally, other different terms used herein may also be deemed equivalents of one another, and the broadest interpretation of such terms, except where limited by specific context, should be given the broadest meaning possible such that the use of one term versus another is in no way intended to be limiting or restrictive.

Introduction

“Auto loan origination” is the process by which a borrower secures from a lender a secured collateral loan (“auto loan”) for the purchase of a new or used vehicle (“automobile”), said vehicle serving as the collateral for the loan. This process generally includes all necessary steps for making a loan, from application on the front end through to disbursement of funds on the back end if successful (or declining to make the loan if unsuccessful).

Various business development activities (“development”) may precede auto loan origination and generally include marketing and related activities intended to encourage, persuade, and/or incentivize would-be borrowers to begin an auto loan application (and thereby begin the auto loan origination process). Some well-known marketing initiatives include pre-approvals and pre-qualifications based on nominal credit score information provided by various credit information companies available to the public. Likewise, auto loan servicing (“servicing”) generally commences upon the conclusion of auto loan origination which culminates in funding the loan after closing. The various stages of the auto loan origination process, as well as the bookend development and servicing processes, are described in more detail herein below.

The overarching foundations of auto loan origination comprise two major components: sound business practices and regulatory compliance. Both of these components are discussed in detail in the following sections.

Prevailing Lending Principles

As well-known and readily-appreciated by skilled artisans, lenders use rigorous policies and analyses when determining if and how much money to lend to loan applicants (“prevailing lending principles”). The methods used by most lenders can be summarized by categorizing lending analysis into five areas colloquially referred to as the “five Cs of credit” (“5Cs”): character, capacity, capital, collateral, and conditions. The 5Cs are used by lenders to gauge the creditworthiness of the potential borrower by weighing each characteristic of the borrower against the conditions of the loan in order to estimate the risk of default on the loan by the borrower. Such methods of evaluating a would-be borrower incorporate both qualitative and quantitative measures and include (but are not limited to) the applicant's credit reports, credit score, income statements, and other information relevant to the applicant's financial situation, as well as objective features of the loan itself. A brief description of each of the 5Cs follows.

“Character” (or “creditworthiness”) is an assessment of the borrower's reliability, intentions, and commitment to repay an auto loan. Because it is important for a lender to have reasonable confidence in the character of a prospective borrower, quantitative indicators such as credit rating and borrowing history (“credit history”), coupled with more qualitative factors such as honesty and integrity, provide strong indications of a borrower's willingness and ability to repay a loan.

Credit history, as an indicator of a borrower's reputation and/or track record for repaying debts, is primarily derived from on the borrower's credit reports that are generated by the one of the major credit bureaus (e.g., Experian, TransUnion, or Equifax) and which contain detailed information about how much an applicant has borrowed in the past and whether the borrower has repaid prior loans on time. These reports also contain information on collection accounts, judgments, liens, and bankruptcies of the borrower for the past seven years in most regards. In addition to the credit bureaus, other credit information entities, such as the Fair Isaac Corporation (“FICO”) for example, use credit report information to create a credit score (or “FICO score”) as a tool for lenders to get a quick snapshot of a would-be borrower's creditworthiness before securing one or more full credit reports (and incurring the greater cost and substantially greater regulatory burdens associated with the latter).

Although an applicant's credit score provides reasonable and objective indicators of the would-be borrower's history of managing and repaying debt, character determinations may also be positively or negatively impacted by additional data collected or retained by the lender that is not part of a credit report. For example, applicants who are existing customers of the lender and have a long track record with the lender, or applicants who fit certain demographic attributes which may be permissibly considered by lenders (i.e., that do not violate the letter or spirit of antidiscrimination laws, such as driving record or physical fitness), can be of relevant objective statistical significance with regard to character, and therefore may weigh in favor of or against the approval of the applicant for the loan.

“Capacity” refers to the ability of the borrower to repay the auto loan (principle and interest) and is critically important to an auto loan decision (approval or disapproval). Foundationally a borrower's capacity is largely determined by income and employment. A borrower's debt-to-income (DTI) ratio—which is the comparison of income against recurring debt payments—provides an objective indication as to the borrower's ability to repay the auto loan (regardless of the borrower's well-meaning intentions). Likewise, gainful employment—and the likelihood of maintaining that employment (or similar employment) throughout the repayment period of the auto loan (generally 3-6 years)—is often dispositive in auto loan approval determinations. The length of time an applicant has been at their job and job stability are key parameters to this determination.

“Capital” comprises the financial assets the borrower has on hand to repay the loan, and refers to both the borrower's monetary assets plus the amount of the down payment (if any). Regarding monetary assets, lenders strive to understand the capital position (e.g., personal wealth) of the prospective borrower because more capital represents the borrower's ability to withstand volatility (e.g., loss of employment) and reassures a lender of repayment of the loan. Similarly, lenders also favorably consider a down payment—that is, the capital the borrower puts towards the automobile being purchased, thereby offsetting the amount of the loan needed to meet the purchase price—where the size of the down payment directly equates to decreased risk of default by the borrower. Stated differently, down payments may indicate, both separately and objectively, a borrower's level of seriousness and commitment to repayment of the loan which, in turn, gives the lender greater assurance that a borrower default is unlikely.

“Collateral” refers to the automobile being purchased with the proceeds of the auto loan, which in turn becomes the tangible asset that acts as the security for said auto loan. This security interest gives the lender strong assurances that the borrower will not default on the auto loan. In practice, auto loan lenders take a collateral lien on the automobile at the time of purchase, and then if the borrower is not able to repay the auto loan in full (including interest) the lender can repossess and sell the collateral (i.e., the automobile) to repay the loan. For this reason, the underlying value of the automobile over time is an important variable in collateral determinations. Collateral assessments also generally include assessing trends in the resale value of the underlying collateral over time to account for the varying loan-to-value ratio expected throughout the life of the loan.

“Conditions” generally refer to the specific parameters of the loan itself and other relevant factors that may increase or decrease the risk of default by the borrower. For example, whereas capacity assessments may consider the merits of the applicant's immediate employment situation, conditions may take into account the business prospects of the applicant's employer and any parent companies of that employer, the condition and health of the employer's industry, as well as broader market conditions affecting the industry, segment, geographic location, and overall economy in which the lender operates and its borrowers engage in commerce. These additional factors may influence the lender's decision to approve or disapprove an auto loan.

Notably, each of the 5C's is not independent of one another, and all five are prudently considered when lenders assess the level of layered risk that could be present in making an auto loan to a borrower. For example, if the borrower has a less-than-stellar credit score, limited asset reserves, and a minimal down payment, the risk layering could be deemed excessive and lead to disapproval of the auto loan application. To a certain extent, these determinations are within the underwriter's discretion and can be somewhat subjective, especially when based on qualitative factors such as occupation, how long the borrower has been in a specific line of work, the reasons as to why a credit score is less than perfect (with some reasons being more acceptable than others), and so on and so forth. The lender must decide, based on all available and permissible criteria, if the borrower is an acceptable risk for the lender to approve the auto loan, as well as whether the auto loan itself can be resold without undue difficulty to third parties who purchase debt obligations (which is not an uncommon practice in the banking and finance industry).

Regulatory Compliance

Auto loan origination, like most forms of lending, is highly regulated at both the state and federal levels, with many of the statutory and regulatory requirements being set forth in a specific set of laws that include but are not limited to the Truth In Lending Act of 1968 (e.g., “Regulation Z” requirements) and the Equal Credit Opportunity Act of 1974 (e.g., “Regulation B” requirements), and the Fair Credit Reporting Act of 1970.

The Truth In Lending Act of 1968 (“TILA”) is a United States federal law designed to promote the informed use of consumer credit by requiring disclosures about its terms and costs in order to standardize the manner in which costs associated with borrowing are calculated and disclosed by lenders to borrowers.

The Equal Credit Opportunity Act of 1974 (“ECOA”) is a United States federal law that makes it unlawful for any creditor (e.g., banks, retailers, bankcard companies, finance companies, and credit unions) to discriminate against any applicant, with respect to any aspect of a credit transaction, on the basis of: (1) race, color, religion, national origin, sex, marital status, or age (provided the applicant has the capacity to contract); (2) to the fact that all or part of the applicant's income derives from a public assistance program; or (3) to the fact that the applicant has in good faith exercised any right under the Consumer Credit Protection Act. ECOA also prevents creditors from excluding from loan decisions any of an applicant's regular sources of income (such as reliable veteran's benefits, welfare payments, Social Security payments, alimony, child support, etc.) and also prohibits creditors from refusing to consider or discounting any of an applicant's income earned from a part-time job, pension, annuity, or retirement benefits program. Furthermore, ECOA requires that creditors inform the applicant whether they have been denied or granted credit within thirty (30) days of receiving a completed application, and give the specific reason(s) why an applicant is denied credit or granted credit differently than under the terms for which the applicant originally applied.

The Fair Credit Reporting Act of 1970 (“FCRA”) is a United States federal law enacted to promote the accuracy, fairness, and privacy of consumer information contained in the files of consumer reporting agencies, and was intended to protect consumers from the willful and/or negligent inclusion of inaccurate information in their credit reports. To that end, the FCRA regulates the collection, dissemination, and use of consumer information, including consumer credit information. The FCRA, together with its subsequent additions and amendments, forms the foundation of consumer rights law in the United States and is enforced in the civil courts by the US Federal Trade Commission, the Consumer Financial Protection Bureau, and private litigants. The FCRA regulates consumer reporting agencies, users of consumer reports, and parties that furnish consumer information to the consumer reporting agencies. Users of the information for credit (i.e., loans) have the following responsibilities under the FCRA: (1) obtaining consumer reports only for permissible purposes under the FCRA; (2) notifying the consumer when an adverse action is taken on the basis of such reports; and (3) identifying the company that provided the report so that the accuracy and completeness of the report may be verified or contested by the consumer.

Infrastructure

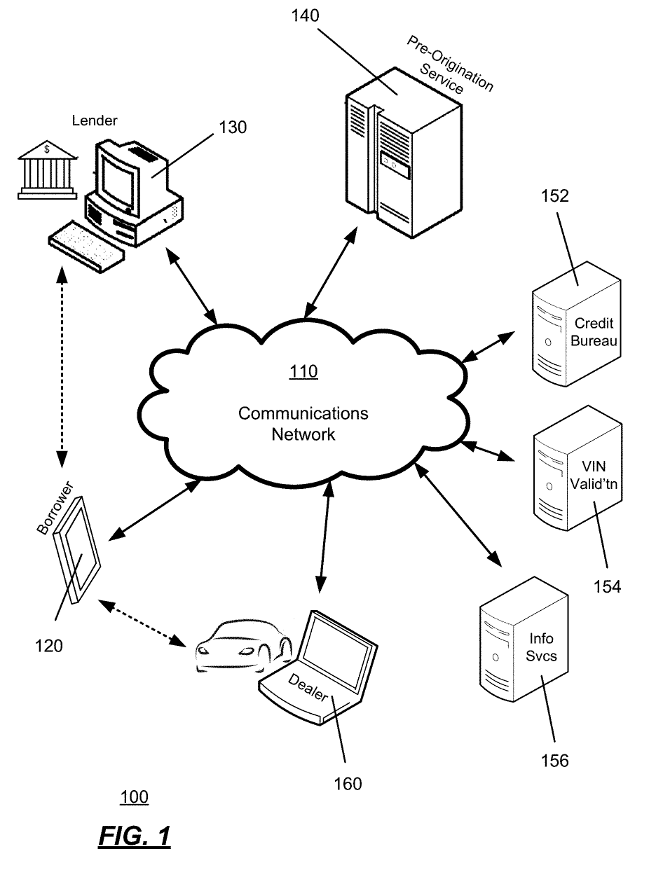

FIG. 1 is a block diagram illustrating an exemplary infrastructure 100 that is capable of being used to secure financing for a purchase of a type that normally requires financing according to the various implementations disclosed herein such as, for example, auto loans and auto loan origination.

In FIG. 1, the exemplary infrastructure 100 allows a borrower 120 (using a wireless device, for example) to connect to a communication network 110, such as the Internet, through which the borrower 120 may also connect to a lender 130 and an automobile dealership 160 (“dealer”) for purposes of arranging financing with the lender 130 for the purchase of an automobile from the dealer 160. In accordance with the various implementations disclosed herein, the lender 130 may provide an automated financing system accessible through the communications network or, for certain implementations, by some other means (such as a kiosk or brick-and-mortar facility, facilitated or otherwise) directly for benefit of the borrower 120 (denoted by the dotted bidirectional arrow between the lender 130 and the borrower 120). The lender 130 may also connect to one or more data providers 152, 154, and 156 to facilitate auto loan origination for the borrower 120.

For certain implementations, the lender 130 may allow the borrower 120 to access an online auto loan origination system from a web page of the lender 130, and to have the lender 130 perform the auto loan origination online through the communications network 110. The borrower 120 may also connect to a web site of the dealer 160 where the borrower may arrange for the purchase of an automobile using financing provided by the lender 130. In some implementations the borrower 120 and the dealer 160 may also interact directly (denoted by the dotted bidirectional arrow between the borrower 120 and the automobile dealership 160).

To facilitate auto loan origination between the borrower 120 and the lender 130, a pre-origination service 140 may be utilized by the lender 130, via the communications network 110, to provide enhancements to the auto loan origination process, enhancements that the lender 130 does not or cannot provide. As such, the various implementations disclosed herein are directed to the utilization of a pre-origination service to streamline the auto loan origination process for benefit of both the lender 130 and the borrower 120.

Auto Loan Origination

“Auto loan origination” is the process by which a borrower secures from a lender a secured credit loan (“auto loan”) for the purchase of a new or used vehicle (“automobile”), said vehicle serving as the collateral for the loan. This process generally includes all the steps for completing a loan.

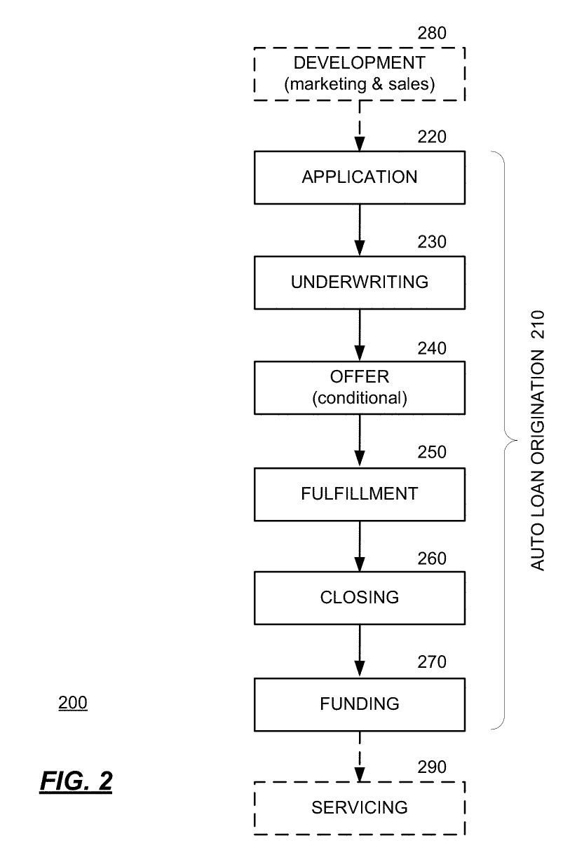

FIG. 2 is a modified block diagram with process flow components 200 illustrating the six-part pipeline of activities that form an exemplary auto loan origination process 210 upon which various implementations disclosed herein are based. As shown, the pipeline process comprises six parts: application 220, underwriting 230, offer 240, fulfillment 250, closing 260, and funding 270.

The auto loan origination process typically commences with the would-be borrower (applicant) obtaining, completing, and filing with the lender a formal application for an auto loan. The formal application process includes not only the applicant completing an application form provided to the applicant by the lender, but it may also include the applicant submitting evidence of current income, current assets, estimates of existing debt obligations, and a current credit score (or permission by the applicant for the lender to obtain the credit score and/or a full credit report on the applicant's behalf).

During the application process, borrowers may also select desired auto loan options (such as payment terms and rates), select add-on products or services (such as payment protection insurance), and executing (signing) the application once all of the application-related tasks are complete. Additionally, lenders may present required disclosures to the applicant during the application process. Regardless, the application process is mostly concerned with the accurate capture of applicant information and does not include any background assessment or approval/disapproval decision-making.

Underwriting is the process of evaluating the loan application, including related documentation and other information about the applicant, to determine whether or not granting the requested loan would comply with approval guidelines and parameters of the lender. The underwriting process also assesses the risk of the loan. Underwriting also includes validating the asset being used as collateral for the loan, i.e., the specific automobile to be purchased with the loan proceeds, and a title search is completed to ensure there are no liens against the property (or other fraudulent activity). Given its information-intensive nature, underwriting can require substantial time and extensive resources to complete. Three important criteria considered during underwriting include the applicant's credit score, income-to-debt ratio, and income (discussed earlier herein).

Notably, underwriting is as much art as science, and there are several different models used by different lenders for performing underwriting for auto loan origination. Although each model may use certain common information, the weights given to each factor considered may differ substantially from lender to lender. Thus while many lenders may start their analysis by obtaining and using an applicant's credit report, the exact methodology for how the data from that credit report is modeled to score the applicant—using a customized set of weights and measures that the lender may have developed to derive the applicant's quantifiable scores or “scorecard”—can vary greatly, but it is the scorecard that the underwriter ultimately relies upon to assess the applicant's risk.

When underwriting of a loan is approved, such approval is generally made with a list of “conditions” that must be met before final approval for the loan can be given and loan documents can be prepared. For example, for auto loans several conditions may pertain to the specific car subsequently selected for purchase by the applicant, and that specific car has attributes such as price, value retention, add-on costs, and so forth that are considered during underwriting.

With the approval of underwriting, various loan options can be modeled and presented to the applicant. These options may differ in a variety of ways such as loan value, interest rate, term, down payment requirements (if any), and other variables to enable the applicant to select the loan that best fits the eventual automobile purchase and borrower preferences.

After an applicant selects an offer, fulfillment then commences to resolve the outstanding conditions set forth in the provisional approval given by underwriting with regard to the specific loan option selected and the specific automobile to be purchased. At a minimum, the Vehicle Identification Number (VIN) of the specific automobile to be purchased must be provided to the lender, along with enough information to enable the lender to verify the seller's ownership of the vehicle and existence of any liens against the vehicle.

Once fulfillment is completed, the loan documents are prepared and presented to the applicant for execution. In some instances, preparation of the loan documents may be undertaken by the lender prior to completion of fulfillment, but execution of the loan documents does not take place until all underwriting conditions are met and fulfillment is completed.

After closing, the applicant typically takes possession of the selected vehicle, and the lender funds the loan. Funding comprises booking the loan, selecting the mode of payment to the party that sold the vehicle to the borrower (cash, online transfer, check, etc.), and disbursal of funds.

As also illustrated in FIG. 2, various business development activities (“development”) 280 may precede auto loan origination 210 and generally include marketing and other related activities intended to encourage, persuade, and/or incentivize would-be borrowers to begin an auto loan application (and thereby begin the auto loan origination process). Likewise, auto loan servicing (“servicing”) 290 generally commences upon the conclusion of auto loan origination 210, i.e., after closing 260 and funding 270 the loan. (Because development 280 and servicing 290 are distinct and separate from auto loan origination 210, they are illustrated using dashed lines.)

Notably, once an application for an auto loan is initiated, the would-be borrower is deemed an applicant for an auto loan, and from that point forward lenders are required to comply with the various federal and state rules and regulations described earlier herein with regard to processing the application and deciding whether or not to make the loan. For example, for loan applications that are disapproved, lenders are required to provide extensive notices and documentation to the applicant explaining the basis for the lender deciding not to approve the loan.

Real-Time Approval

As described earlier herein, there are many factors that contribute the decision-making process a lender undertakes in determining whether or not to grant an auto loan, and compliance with the various federal and state rules and regulations is of paramount importance to these lenders and often renders the decision-making process potentially complicated and time-consuming. This is especially the case for applicants who do not fall into the objectively easily approved ranges of the various criteria that are evaluated and considered, for which additional consideration may be warranted that still leads to an approval, or for which disapproval of the loan is the outcome. As such, auto loan applications can be divided among three groups: (1) those that may be easily approved objectively; (2) those requiring special approval often for subjective reasons (but cannot be objectively approved); and (3) those that are ultimately disapproved (whether objectively or for not qualifying for a special approval). Most federal and state rules and regulations pertain to this last category in order to ensure that any disapproval of the loan application is only for objective and fair reasons, and is not in any way due to illegal reasons (e.g., discrimination against any protected class of persons), as well as to ensure that an applicant still receives special approval for a loan when so warranted even if not objectively approved.

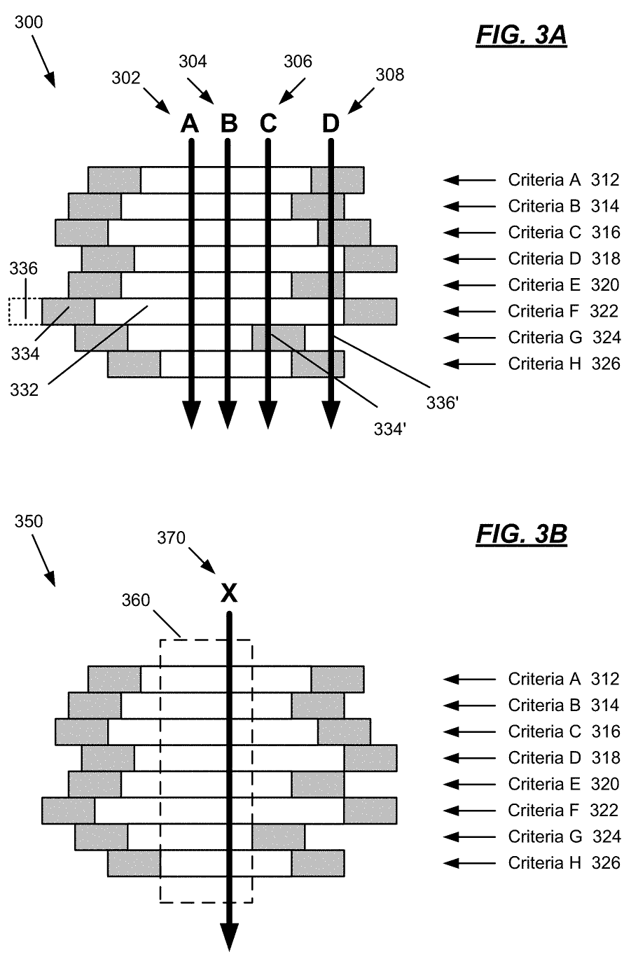

FIG. 3A is a modified block diagram 300 illustrating processing of auto loan applications from each of the three groups of applicants as well as displaying shortcomings addressed by various implementations disclosed herein. In FIG. 3A, four auto loan applications denoted A, B, C, and D (302, 304, 306, and 308 respectively) are evaluated for auto loan approval against a plurality of imperfectly overlapping criteria 312, 314, 316, 318, 320, 322, 324, and 326. As shown for Criteria F 322, which are representative for all of the criteria shown, each of the criteria groupings may comprise a range of values having a portion indicating objective approval 332 (central blocks), objective disapproval 336 (represented as beyond the criteria boundaries), and consideration for special approval or disapproval 334 (shown in gray just beyond the limits of the objective approval range). For example, whereas Applicants A and B (302 and 304 respectively) meet the approval criteria in all instances—and thus may be deemed objectively easy approvals—Applicant C 306 requires consideration for special approval 334′ with regard to Criteria G 324, and Applicant D 308 must be disapproved 336′ with regard to Criteria G 324.

For these reasons, processing loan applications is difficult and time-consuming for lenders who are effectively unable to provide real-time decision-making for auto loan origination because of the possibility that any particular application may require special approval or disapproval, and this cannot be determined by the lender before an application is filed and legal and regulatory compliance requirements are in force. This inflexible and antiquated approach, however, has not kept pace with technology advances in the auto purchasing marketplace where today would-be borrowers demand quick decision-making and near-instant financing for their automobile purchases. Instead, despite the availability of computer processing automation, ubiquitous communications, and consumer demand, each step in the auto loan origination process continues to be incremental, slow, and highly tailored to declines and special approvals that cannot be easily standardized or automated despite the fact that the vast majority of auto loan applications fall into the “easily approved objectively” group ripe for real-time approvals at all six stages of auto loan origination.

To address the several shortcomings of traditional auto loan origination, various implementations disclosed herein are directed to dynamic auto loan origination that effectively separates the objectively-easy-to-approve loan applicants that are entirely suitable for automated, streamlined, and fast-tracked auto loan origination (which, again, comprise the vast majority of auto loan applications and which can be provided with real-time approvals) from those loan applicants that may be disapproved or that may require special consideration leading to approval or disapproval (for which traditional auto loan origination processes can continue to serve). Furthermore, for several such implementations, the separation of the easy approvals from the other groups is performed by a third-party non-lending pre-origination provider that is distinct and separate from a lender (herein referred to as the “third-party provider” or simply as a “provider”).

FIG. 3B is a modified block diagram 350, similar to modified block diagram 300 shown in FIG. 3A, but featuring a fast-track 360 approval pipeline for the objectively easy approvals such that applicants for auto loans such as the applicant denoted as X (370) can be provided real-time auto loan approvals because such applicants are fully vetted in advance by the third-party provider. Stated differently, the lender is able to provide real-time approvals to applicants referred to it by the third-party provider because the third-party provider only refers applicants that are objectively easy approvals for the lender based on the criteria it uses for such approvals as provided by the lender to the provider in advance in the form of requirement parameters. These requirement parameters, in turn, enable the third-party provider to evaluate potential applicants independently and in advance of the lender's loan origination process, identifying and referring on to the lender those applicants that are objectively easy approvals (and therefore suitable for automated fast-track processing and real-time approvals) and disapproving for fast-track real-time processing all other applicants.

The benefits of this dynamic approach are based on legal effect whereby non-lenders are not subject to the arduous regulatory requirements placed on lenders when declining a loan application. Thus as an intermediary between the applicants and the lender, the provider can both relieve the lender of the regulatory burdens of disapproving loan applications by providing as formal applicants only those would-be borrowers who are objectively easy approvals suitable for much more efficient real-time auto loan origination processing and approval (including, for certain implementations, closing and funding) while also providing the vast majority of auto loan applicants who qualify for objectively easy approval to take advantage of real-time auto loan origination.

Stated differently, the third-party provider is not offering a loan at all (hence “not a lender”) but, instead, the third-party provider is only offering a pre-qualification opportunity to potential borrowers that could result in a “firm offer of credit” on behalf of the lender to that borrower. By participating in the pre-qualification process with the third-party provider, the would-be borrower is effectively choosing to opt out of the rules and regulations that apply only to lenders because the pre-qualification process (including the pre-application itself) is not in fact a formal application. As such, declines by the third-party provider (as a non-lender) are akin to merely concluding that the would-be borrower is not eligible for an offer (specifically, a “firm offer of credit”) and thus declines are not subject to the lending regulations and requirements that otherwise prevent lenders from providing real-time auto loan origination approvals. In other words, the third-party provider is merely declining fast-track real-time consideration of certain applicants while the traditional auto loan origination processes of the lender are still available to such applicants (albeit without real-time approval).

Accordingly, all descriptions of the pre-origination process disclosed herein, including but not limited to the pre-application and pre-underwriting, only pertain to pre-qualification and fast-track processing, and do not pertain to the opportunity to apply for (and be formally approved for or declined from) an auto loan with the lender.

Auto Loan Pre-Origination

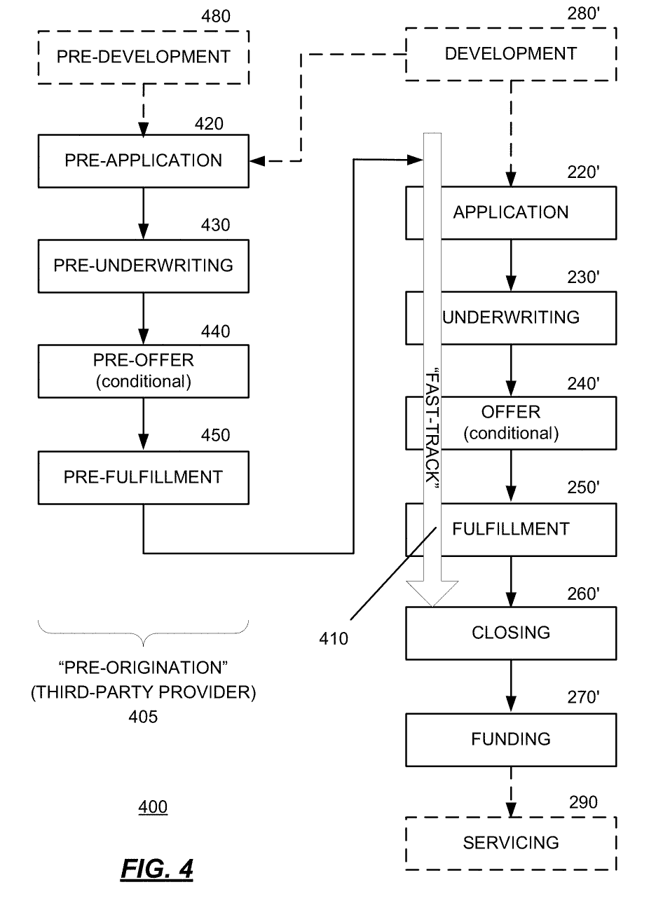

FIG. 4 is a modified block diagram with process flow components 400 based on the auto loan origination pipeline 210 shown in FIG. 2 but further illustrating the modified pipeline of activities that form an exemplary dynamic auto loan origination process featuring fast-track processing 410 for real-time approvals to which the various implementations disclosed herein are directed. In FIG. 4, the traditional six-part pipeline comprising application 220′, underwriting 230′, offer 240′, fulfillment 250′, closing 260′, and funding 270′ are modified such that, in the first four parts, a lender is able to accept applicants directly referred to it by the third-party provider where the applicants have already been determined to meet the requirement parameters for objectively easy approval and fast-tracked through to closing 260′ in real-time. Additionally, closing 260′ and funding 270′ may also be automated and streamlined in a manner that enables these tasks to also be performed in real-time.

The fast-track processing 410, in turn, is made possible by the pre-origination processing 405 performed by a third-party provider to vet potential applicants by using lender-provided requirement parameters to perform preliminary versions of the application, underwriting, offer, and fulfillment tasks illustrated as pre-application 420, pre-underwriting 430, pre-offer 440, and pre-fulfillment 450, effectively replicating the corresponding parts of the lender's auto loan origination process 210 of FIG. 2 but performing these tasks in a streamlined automated fashion to provide real-time decisioning (approval or disapproval) for fast-track processing 410 by the lender.

As also shown in FIG. 4, for certain implementations the lender's development tasks 280′ (again, shown in dashed lines to distinguish it from the components comprising auto loan origination 210) may also be modified to target and direct potential fast-track applicants to the third-party provider's pre-origination process 405. For example, the lender might perform pre-qualification, pre-approval, or other creditworthiness checks of its existing customers and direct those potential applicants seemingly eligible for fast-track processing to the third-party provider. Likewise, the third-party provider may undertake its own pre-development activities 480 (similarly shown in dashed lines to distinguish it from the components comprising one or more activities of pre-application 420 through pre-fulfillment 450 of pre-origination 405) to solicit applicants to its pre-origination processing 405 and refer on to the lender those applicants meeting the lender's requirement parameters for fast-track approval. In some implementations, the third-party provider may also work with more than one lender, in which case the third-party provider may help the applicant select one lender from among a plurality of lenders to complete the auto loan. Likewise, in some implementations the lender may work with more than one third-party provider to vet potential fast-track applicants.

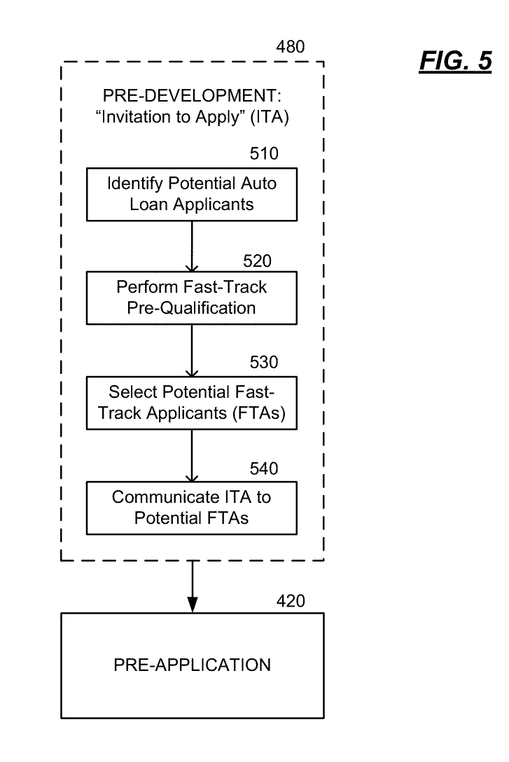

FIG. 5 is a modified block diagram with process flow components of the pre-development function 480 of FIG. 4 to which the various implementations disclosed herein are directed. In FIG. 5, pre-development 480 is performed on potential applicants to identify those best suited for an “invitation-to-apply” (ITA) for fast-track auto loans featuring real-time decisioning. At 510, the provider first identifies potential auto loan applicants. This may be based on information provided by the lender, by information developed by the provider, or by information provided by a third-party such as a credit bureau, automobile membership group, and so forth. At 520, the provider then performs fast-track pre-qualification checks such as obtaining a soft credit score for potential applicants and, at 530, comparing this credit score against internal criteria developed by the provider for identifying and selecting those potential applicants most likely to quality for fast-track processing with the lender. At 540, the provider may then communicate the “invitation-to-apply” to the selected potential applicants to encourage their entry into the pre-application process 420 for fast-track auto loan consideration via the dynamic auto loan origination 410.

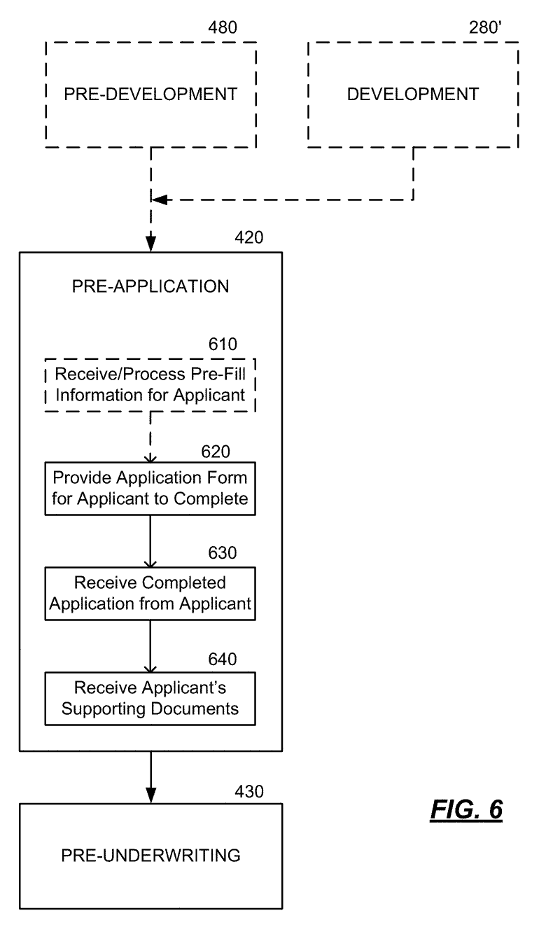

FIG. 6 is a modified block diagram with process flow components of the pre-application function 420 of FIG. 4 to which the various implementations disclosed herein are directed. In FIG. 6, the provider may receive and process at 610 pre-fill information for an applicant for fast-track processing of an auto loan. This information may come from prequalification assessments performed by the pre-development function 480 or by the development activities 280′ of the lender, for example, based on its existing customers. However, for certain implementations, applicants for fast-track processing may also initiate the process on their own (e.g., through the provider's website) without coming from the pre-development 480 or development 280′ functions, and there would be no pre-fill information for those applicants; accordingly, this pre-fill step 610 only applies in specific instances (and is thus shown in dashed lines to indicate that, for certain implementations, this step would not be performed). At 620, the applicant is provided an application form for the applicant to complete, the application form pre-filled with applicant information the provider has on hand if available (and regardless of source). At 630, the provider then receives the completed application from the applicant (generally upon an indication of completion by the applicant in an automated system) and, at 640, also receives any supporting documentation the applicant may have been prompted to supply during applicant's completion of the application form. Once pre-application 420 is completed, pre-underwriting 430 may commence.

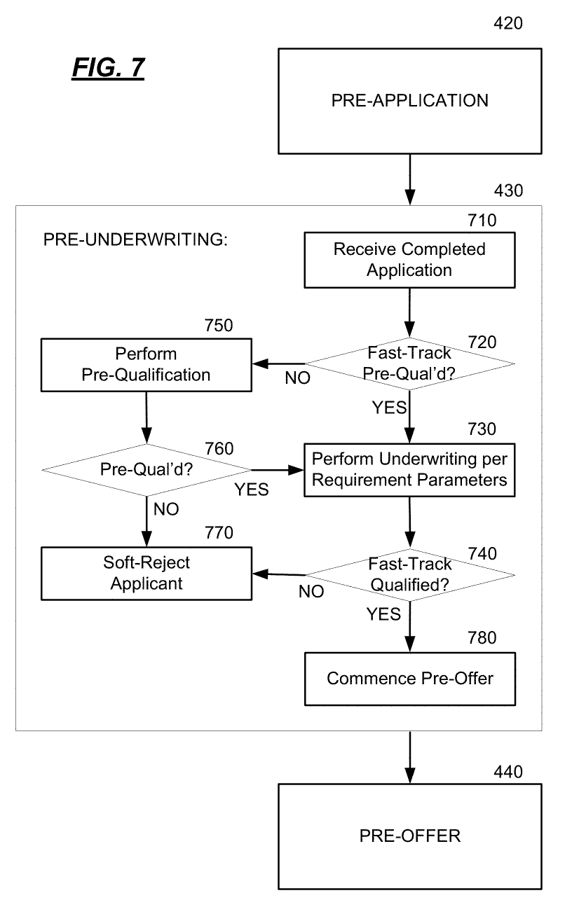

FIG. 7 is a modified block diagram with process flow components of the pre-underwriting function 430 of FIG. 4 to which various implementations disclosed herein are directed. In FIG. 7, once pre-application 420 is completed, pre-underwriting 430 commences at 710 by receiving the completed application and, at 720, determining if the applicant has been previously pre-qualified for fast-track processing. Such pre-qualification for fast-track processing may occur during the pre-development 480 or development 280′ processes previously described. If not, then at 750 a fast-track pre-qualification is performed and, if the applicant is not pre-qualified at 760, then at 770 the applicant receives a soft-rejection (e.g., a rejection indicating that the applicant is not eligible for fast-track loan application processing but may still be eligible for a loan through the lender's direct auto loan origination process without real-time decisioning). On the other hand, for those applicants that are prequalified (as determined at either 720 or 760), at 730 underwriting processes are performed on the application in accordance with the requirement parameters provided by the lender in order for the provider to determine at 740 whether the applicant is an objectively easy approval for an auto loan and thus eligible for fast-track processing (and real-time approval) by the lender. If so, then at 780 the application for the fast-track applicant (“FTA”) is forwarded to pre-offer processing 440 (affirming the pre-qualification determination); if not, then at 770 the applicant receives a soft-rejection (in which case the pre-qualification resulted in a false-positive).

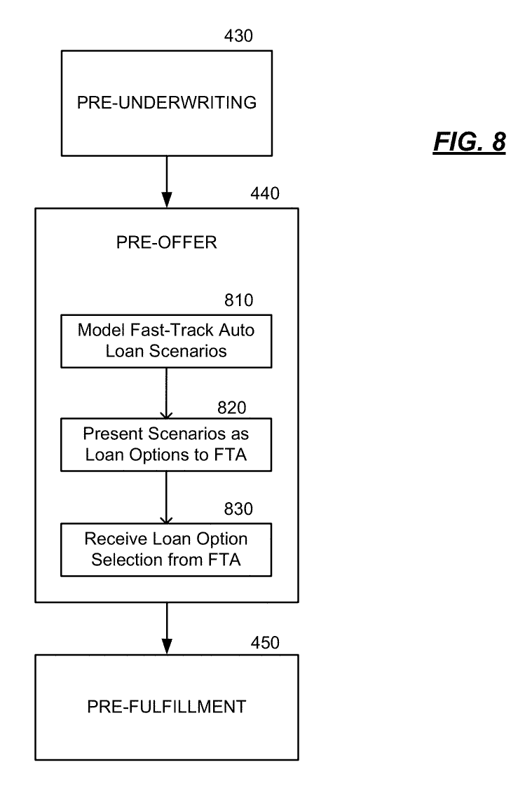

FIG. 8 is a modified block diagram with process flow components of the pre-offer function 440 of FIG. 4 to which various implementations disclosed herein are directed. In FIG. 8, the pre-offer process 440 commences by modeling various fast-track auto loan scenarios to determine specific options for auto loans available to the applicant for fast-track processing. These options are then presented to the applicant at 820 and, at 830, the applicant's selection is received identifying the specific loan desired for the formal application. For certain implementations the provider may present auto loan options from more than one lender, and thus the applicant's selection of the specific loan desired also constitutes the lender selection for such implementations. Following receipt of the fast-track applicant's selection of the specific loan product (and lender, if applicable), pre-fulfillment 450 may then commence.

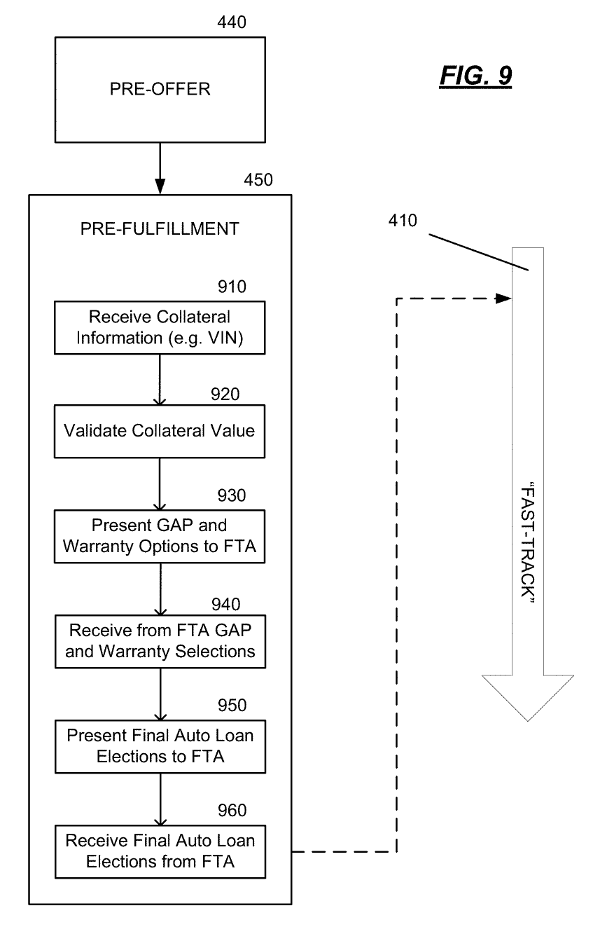

FIG. 9 is a modified block diagram with process flow components of the pre-fulfillment function 450 of FIG. 4 to which various implementations disclosed herein are directed. In FIG. 9, pre-fulfillment 450 may commence at 910 with receipt of information pertaining to the collateral for the loan, that is, information for that automobile that is to be purchased using the proceeds of the auto loan sought by the applicant. This information may include the Vehicle Identification Number for the subject automobile. At 920, the collateral is assessed to validate its value with regard to the auto loan amount. At 930, Guaranteed Automobile Protection (GAP) and Automobile Service Contracts (ASCs) are presented to the applicant for selection and approval, and these selections/approvals then are received at 940. At 950, final auto loan elections are then presented to the applicant for final approval and execution. Then, after receiving at 960 final elections/executions from the applicant, and presuming that all other conditions of underwriting have been met (not shown), the application is then directed by the provider to the lender with an indicator that the application meets the requirement parameters for fast-track processing 410 and real-time approval.

Dynamic Auto Loan Origination

By leveraging pre-origination processing by a non-lender third-party provider, lenders can offer fast-track auto loan origination to provide qualified applications with real-time approvals for auto loans. These processes can also be readily adapted to other types of loans and financing as well.

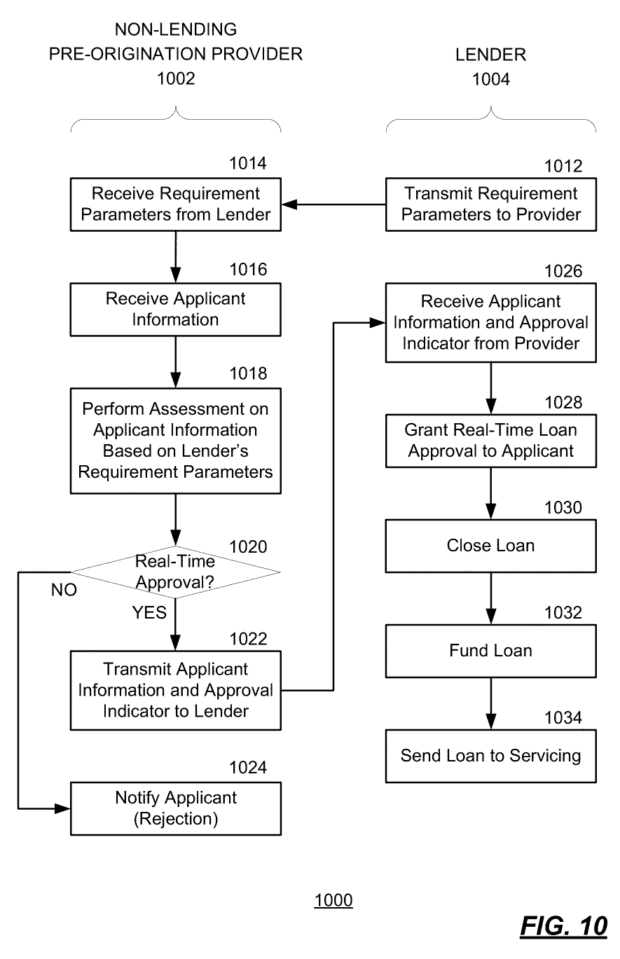

FIG. 10 is a process flow diagram 1000 of an exemplary process for dynamic auto loan origination to which various implementations disclosed herein are directed. In FIG. 10, dynamic auto loan origination commences at 1012 when the lender 1004 provides the requirement parameters to the third-party provider 1002, the requirement parameters providing the information required for the third-party provider 1002 to perform the pre-origination functions (including pre-underwriting) based on the lender's approval criteria to identify and affirm eligibility of applicants for fast-track processing leading to real-time loan approvals. At 1014, the provider 1002 receives the requirement parameters and, at 1016, begins to receive applicant information from various sources (the applicant, the lender, third party credit reporting agencies, etc.) relevant to the requirement parameters for fast-track processing and real-time auto loan approvals.

At 1018, the provider 1002 then performs an assessment of the applicant based on the application information in view of the lender's requirement parameters and determines, at 1020, whether the applicant qualifies for fast-track processing and real-time auto loan approval. If not, then the applicant is notified of the rejection, e.g., a soft rejection, at 1024.

If the applicant is approved for fast-track processing at 1020, then at 1022 the applicant information (e.g., application and supporting documents) and an approval indicator (indicating the specific loan option) are sent to the lender which, at 1026, receives same and, at 1028, performs fast-track processing to grant a real-time loan approval to the applicant. The lender then proceeds to close the loan at 1030, fund the loan at 1032, and send the loan to servicing 1034, any or all of which may also be performed in real-time by the lender in select implementations.

As illustrated in FIG. 10, various implementations disclosed herein are directed to loan pre-origination performed by a non-lending pre-origination provider separate from a lender (“provider”) comprising: receiving from the lender a plurality of requirement parameters for a real-time approval of one or more loans offered by the lender; receiving a first applicant information from a first applicant seeking a first loan from the lender; performing an assessment of the first applicant information to derive assessment results, the assessment based on the plurality of requirement parameters applied to the first applicant information, and the assessment results indicating whether the first applicant qualifies for the real-time approval of at least one loan from among the one or more loans offered by the lender; transmitting to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender; and notifying the first applicant that the first applicant does not qualify for the real-time approval of the at least one loan from among the one or more loans offered by the lender if the assessment results indicate that the first applicant does not qualify for the real-time approval of at least one loan from among the one or more loans offered by the lender. Although described earlier herein in the exemplary context of auto loans, these various implementations are in no way intended to be limited to just auto loans but, instead, are directed to any loan or financing applications or other services without limitation.

As also illustrated by FIG. 10, various implementations disclosed herein are also directed to loan origination performed by a lender comprising: transmitting to a non-lending pre-origination provider separate from the lender (“provider”) a plurality of requirement parameters for real-time approval of one or more loans by the lender; receiving from the provider a first applicant information from a first applicant seeking a first loan from the lender, and an indicator for the lender to grant real-time approval of at least one loan from among the one or more loans offered by the lender based on an assessment performed by the provider that indicated that the first applicant qualifies for the real-time approval of the at least one loan from among the one or more loans offered by the lender, the assessment based on the first applicant information and the plurality of requirement parameters; and granting real-time approval of the at least one loan from among the one or more loans offered by the lender to the applicant. Again, although described earlier herein in the exemplary context of auto loans, these various implementations are in no way intended to be limited to just auto loans but, instead, are directed to any loan or financing applications or other services without limitation.

Notably, although as shown in FIG. 10 the provider and the lender are separate entities performing separate functions, this does not necessarily limit the lender from seamlessly providing the functionality of the provider (e.g., by embedding access to it on the lender's website), and specific implementations disclosed herein are directed to embedding the provider's functionality into the lender's website (and equivalents). For such implementations, the embedded functionality for the pre-qualification provided by the provider may or may not be perceived as “separate” from the other functionality on the lender's website by the would-be borrower, although the would-be borrower would presumably be able to distinguish between a pre-origination process “pre-qualification” (for a “firm offer of credit” and fast-track processing of an auto loan application) from directly proceeding with completing an auto loan application without participating in any pre-qualification (and without fast-track approval). Accordingly, the concept of “separateness” as between the provider and the lender, as used herein, primarily pertains to the distinction between a pre-qualification process by the provider versus a bona fide auto loan application formally submitted to the lender and is not intended to unnecessarily bifurcate the provider's pre-origination process from other functionality offered by and through the lender and its website, for example.

In addition to the foregoing, and for certain implementations herein disclosed, secure interactions between the lender and the pre-origination provider may also be facilitated by a commonly-shared intermediary that in effect provides a common system for use by both the lender and the provider to perform any or all of the functions and/or steps illustrated, for example, in FIG. 4 and FIG. 10.

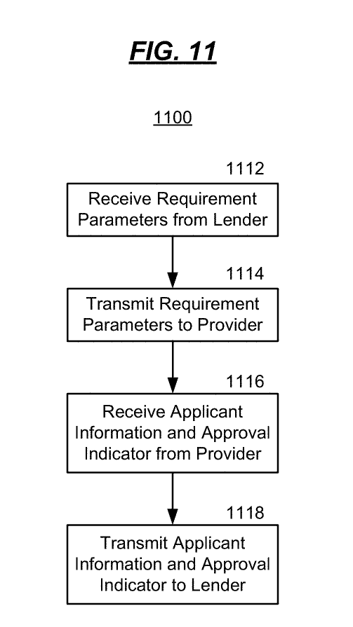

FIG. 11 is a process flow diagram 1100 of basic functions for an intermediary enabling the dynamic auto loan origination services illustrated, for example, in FIG. 4 and FIG. 10 as between a lender and a provider to which select implementations disclosed herein may be directed. In FIG. 11, the intermediary may receive the requirement parameters from the lender at 1112, and then at 1114 provide these requirement parameters to the provider. At 1116, the intermediary may then receive the applicant information and approval indicator from the provider and, at 1118, provide the applicant information and approval indication to the lender. Additionally, the intermediary may perform for the lender or the provider, respectively, automated completion of any of the functions indicated in the illustrations, for example, in FIG. 4 and FIG. 10

Thus, as illustrated in FIG. 11, certain implementations disclosed herein are directed to dynamic auto loan origination systems, methods, software, and hardware communicatively coupled to both a lender and a non-lending pre-origination provider separate from a lender (“provider”) that is configured to: receive from the lender a plurality of requirement parameters for a real-time approval of one or more loans offered by the lender; transmit to the provider the plurality of requirement parameters for real-time approval of one or more loans by the lender; receive from the provider first applicant information from a first applicant, and an indicator for the lender to grant real-time approval of at least one loan from among the one or more loans offered by the lender based on an assessment performed by the provider that indicates that the first applicant qualifies for the real-time approval of the at least one loan from among the one or more loans offered by the lender, the assessment based on the first applicant information and the plurality of requirement parameters; and transmit to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender.

Computing Environment

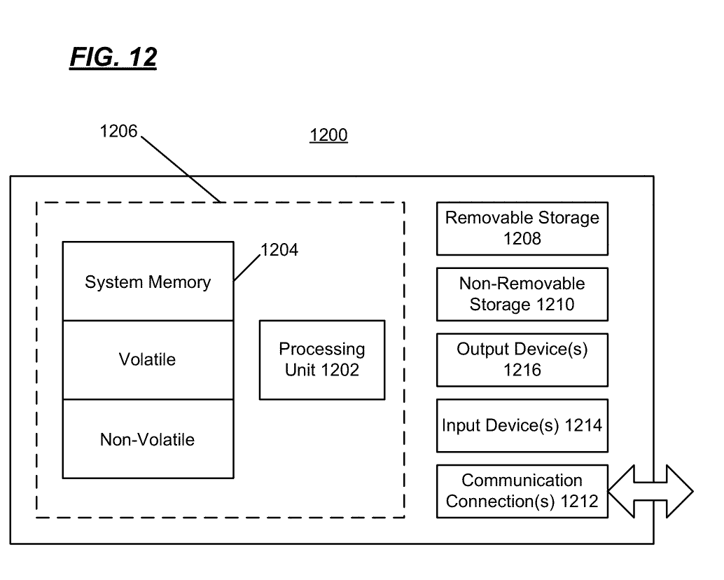

FIG. 12 is a block diagram of an example computing environment that may be used in conjunction with example implementations and aspects. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 12, an exemplary system for implementing aspects described herein includes a computing device, such as computing device 1200. In a basic configuration, computing device 1200 typically includes at least one processing unit 1202 and memory 1204. Depending on the exact configuration and type of computing device, memory 1204 may be volatile (such as random access memory (RAM)), non-volatile (such as read-only memory (ROM), flash memory, etc.), or some combination of the two. This basic configuration is illustrated in FIG. 12 by dashed line 1206 as may be referred to collectively as the “compute” component.

Computing device 1200 may have additional features/functionality. For example, computing device 1200 may include additional storage (removable and/or non-removable) including, but not limited to, magnetic or optical disks or tape. Such additional storage is illustrated in FIG. 12 by removable storage 1208 and non-removable storage 1210.

Computing device 1200 typically includes a variety of computer readable media. Computer readable media can be any available media that can be accessed by device 1200 and include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 1204, removable storage 1208, and non-removable storage 1210 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the information and which can be accessed by computing device 1200. Any such computer storage media may be part of computing device 1200.

Computing device 1200 may contain communication connection(s) 1212 that allow the device to communicate with other devices. Computing device 1200 may also have input device(s) 1214 such as a keyboard, mouse, pen, voice input device, touch input device, and so forth. Output device(s) 1216 such as a display, speakers, printer, and so forth may also be included. All these devices are well-known in the art and need not be discussed at length here.

Computing device 1200 may be one of a plurality of computing devices 1200 inter-connected by a network. As may be appreciated, the network may be any appropriate network, each computing device 1200 may be connected thereto by way of communication connection(s) 1212 in any appropriate manner, and each computing device 1200 may communicate with one or more of the other computing devices 1200 in the network in any appropriate manner. For example, the network may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

General Implementations

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding.

Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims.

Particular implementations are now described with reference to block diagrams and/or operational illustrations of methods. It should be understood that each block of the block diagrams and/or operational illustrations, and combinations of blocks in the block diagrams and/or operational illustrations, may be implemented by analog and/or digital hardware, and/or computer program instructions. Computer programs instructions for use with or by the implementations disclosed herein may be written in an object oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system.

The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non volatile media, volatile media, and transmission media. Non volatile media may include, for example, optical or magnetic disks, such as the storage device. Volatile media may include dynamic memory, such as main memory. Transmission media may include coaxial cables, copper wire and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the following claims.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A method for loan pre-origination performed by a non-lending pre-origination provider separate from a lender (“provider”), the method comprising:
receiving from the lender a plurality of requirement parameters for a real-time approval of one or more loans offered by the lender;
receiving a first applicant information from a first applicant seeking a first loan from the lender;
performing an assessment of the first applicant information to derive assessment results, the assessment based on the plurality of requirement parameters applied to the first applicant information, and the assessment results indicating whether the first applicant qualifies for the real-time approval of at least one loan from among the one or more loans offered by the lender;
transmitting to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender; and
notifying the first applicant that the first applicant does not qualify for the real-time approval of the at least one loan from among the one or more loans offered by the lender if the assessment results indicate that the first applicant does not qualify for the real-time approval of at least one loan from among the one or more loans offered by the lender.

2. The method of claim 1, wherein receiving first applicant information comprises:
providing to the applicant an application form; and
receiving from the applicant the application form completed.

3. The method of claim 1, wherein receiving first applicant information further comprises:
determining if the first applicant is a known applicant;
pre-populating the application form for the known applicant with known information corresponding to the known applicant prior to providing the known applicant with the application form.

4. The method of claim 1, further comprising:
determining for a known applicant if the known applicant is also an invitation-to-apply (ITA) applicant having a pre-application creditworthiness information on file with the provider or on file with the lender;
using the pre-application creditworthiness information for the ITA applicant when performing the assessment; and
obtaining real-time creditworthiness information for the first applicant when the first applicant is not an ITA applicant, and using the real-time creditworthiness information for the ITA applicant when performing the assessment.

5. The method of claim 1, wherein performing an assessment of the first applicant information to derive assessment results further comprises:
performing pre-underwriting to ascertain whether the first applicant meets the plurality of requirement parameters related to underwriting by the lender.

6. The method of claim 5, wherein performing an assessment of the first applicant information to derive assessment results further comprises:
providing one or more pre-offer options to the first applicant if the first applicant meets the plurality of requirement parameters related to underwriting, each pre-offer option corresponding to a loan option from among a plurality of loan options offered by the lender for which the applicant meets the plurality of requirement parameters related to the underwriting by the lender.

7. The method of claim 6, wherein performing an assessment of the first applicant information to derive assessment results further comprises:
receiving from the first applicant a pre-offer selection from among the one or more pre-offer options if the one or more pre-offer options are provided to the first applicant.

8. The method of claim 7, wherein the pre-offer selection from among the one or more pre-offer options corresponds to an auto loan.

9. The method of claim 7, wherein performing an assessment of the first applicant information to derive assessment results further comprises:
performing pre-fulfillment on the pre-offer selection if a pre-offer selection is received from the first applicant.

10. The method of claim 1, wherein notifying the first applicant that the first applicant does not qualify for the real-time approval of the at least one loan from among the one or more loans offered by the lender, further comprises directing the applicant to apply directly with the lender.

11. The method of claim 1, wherein notifying the first applicant that the first applicant does not qualify for the real-time approval of the at least one loan from among the one or more loans offered by the lender, further comprises directing the applicant to an alternate lender.

12. The method of claim 1, wherein the at least one loan from among the one or more loans offered by the lender is an auto loan.

13. A method for loan origination performed by a lender, the method comprising:
transmitting to a non-lending pre-origination provider separate from the lender (“provider”) a plurality of requirement parameters for real-time approval of one or more loans by the lender;
receiving from the provider:
a first applicant information from a first applicant seeking a first loan from the lender, and
an indicator for the lender to grant real-time approval of at least one loan from among the one or more loans offered by the lender based on an assessment performed by the provider that indicated that the first applicant qualifies for the real-time approval of the at least one loan from among the one or more loans offered by the lender, the assessment based on the first applicant information and the plurality of requirement parameters; and
granting real-time approval of the at least one loan from among the one or more loans offered by the lender to the applicant.

14. The method of claim 13, wherein the plurality of requirement parameters comprise objective quantifiable criteria used for determining creditworthiness of a potential applicant pertaining to application, underwriting, conditional offering, fulfillment, closing, and funding of one or more loans by the lender to which the plurality of requirement parameters pertain.

15. The method of claim 14, wherein the plurality of requirement parameters comply with applicable lending regulations and prevailing lending principles of the lender.

16. The method of claim 13, wherein granting real-time approval of the at least one loan from among the one or more loans offered by the lender to the applicant is based on the received indicator obviating the need for performing underwriting, conditional offering, or fulfillment to the same extent the lender would perform but for the indicator and the first applicant information received from the provider.

17. The method of claim 13, wherein a real-time underwriting is provided for the first applicant based on the indicator and the first applicant information received from the provider which is distinguishable from non-real-time underwriting undertaken by the lender for a second applicant that directly applies for financing directly from the lender.

18. The method of claim 13, wherein a real-time fulfillment is provided for the first applicant based on the indicator and the first applicant information received from the provider which is distinguishable from non-real-time fulfillment undertaken by the lender for a second applicant that directly applies for financing directly from the lender.

19. The method of claim 13, wherein the at least one loan from among the one or more loans offered by the lender is an auto loan.

20. A non-transitory computer-readable medium comprising computer-readable instructions for dynamic auto loan origination communicatively coupled to both a lender and a non-lending pre-origination provider separate from a lender (“provider”), the computer-readable instructions comprising instructions that cause the processor to:
receive from the lender a plurality of requirement parameters for a real-time approval of one or more loans offered by the lender;
transmit to the provider the plurality of requirement parameters for real-time approval of one or more loans by the lender;
receive from the provider:
a first applicant information from a first applicant, and
an indicator for the lender to grant real-time approval of at least one loan from among the one or more loans offered by the lender based on an assessment performed by the provider that indicated that the first applicant qualifies for the real-time approval of the at least one loan from among the one or more loans offered by the lender, the assessment based on the first applicant information and the plurality of requirement parameters; and
transmit to the lender the first applicant information and an indicator for the lender to grant real-time approval of the at least one loan from among the one or more loans offered by the lender if the assessment results indicate that the first applicant qualifies for the real-time approval of the at least one loan from among the one or more loans offered by the lender.
